(19) United States
(12) Patent Application Publication
(10) Pub. No.: US 2024/0374937 A1
(43) Pub. Date: Nov. 14, 2024

(54) LOCKING MECHANISM FOR RESPIRATOR ASSEMBLY

(71) Applicant: Honeywell Safety Products USA, Inc., Charlotte, NC (US)

(72) Inventors: Oliver GOMEZ RODRIGUEZ, Mexico City (MX); Sergio Eladio ABURTO, Mexico City (MX)

(21) Appl. No.: 18/314,530

(22) Filed: May 9, 2023

(51) Int. Cl. A62B 23/02; A62B 18/02

(52) U.S. Cl. CPC A62B 23/02; A62B 18/025

(57) ABSTRACT

Respirator assemblies, facepieces, methods, and/or the like are provided. In some embodiments, a respirator includes: a connector having a connector base and a connector column, wherein the connector base defines one or more mechanical stops, wherein the connector column defines connector threading; an adaptor comprising an adaptor base and an adaptor column, wherein the adaptor column defines adaptor threading configured to operably engage with the connector threading of the connector such that the adaptor and the connector are operably engaged; a respirator cartridge comprising a housing; and a facepiece comprising one or more attachment slots defining one or more cavities, wherein the one or more cavities are configured to receive the one or more mechanical stops such that the connector refrains from moving relative to a facepiece.

### TECHNICAL FIELD

The present disclosure relates generally to a respirator assembly. In particular, it relates to a locking mechanism for components of a respirator assembly.

### BACKGROUND

A respirator may include a facepiece configured to be fit to a user's face and a respirator assembly including a respirator cartridge and a filter. Respirator assemblies may also include additional components for fitting the respirator assembly to the facepiece, including an adaptor configured to adapt a connector for the facepiece to the respirator cartridge. These components may be assembled during production of the respirator. If the components are not securely fastened together, then one or more of them may become loose or disconnected during use of the respirator. Further, certain mechanisms of connecting the assembly components may cause the assembly components to move together, which may destabilize the respirator assembly if one component needs to be removed but others do not.

Through applied effort, ingenuity, and innovation, Applicant has solved problems relating to securing components for respirator assemblies by developing solutions embodied in the present disclosure, which are described in detail below.

### SUMMARY

In general, embodiments of the present disclosure provide facepieces, assemblies, methods, and/or the like.

According to various embodiments, there is provided a respirator including a connector having a connector base and a connector column, wherein the connector base defines one or more mechanical stops, wherein the connector column defines connector threading; an adaptor comprising an adaptor base and an adaptor column, wherein the adaptor column defines adaptor threading configured to operably engage with the connector threading of the connector such that the adaptor and the connector are operably engaged; a respirator cartridge; and a facepiece comprising one or more attachment slots defining one or more cavities, wherein the one or more cavities are configured to receive the one or more mechanical stops such that the connector refrains from moving relative to a facepiece.

In some embodiments, one or more of the connector threading and the adaptor threading are bayonet threads.

In some embodiments, the respirator further includes a gasket disposed between the adaptor and the respirator cartridge, wherein the adaptor column further defines a lip, and wherein the gasket is configured to be operably engaged with the lip of the adaptor.

In some embodiments, the respirator cartridge is configured to receive one or more filters within the housing.

In some embodiments, the respirator assembly is configured to be operably engaged with a facepiece.

According to various embodiments, there is provided a method for using a respirator assembly, the method including: inserting, by one or more mechanical stops, a connector into one or more cavities of an attachment slot of a facepiece; attaching, by a connector threading and an adaptor threading, the connector to an adaptor; and securing, by one or more adaptor protrusions, the adaptor to a respirator cartridge.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a front elevation view of an example facepiece in accordance with various embodiments of the present disclosure;

FIG. 2 is an exploded view of an example respirator assembly in accordance with various embodiments of the present disclosure;

FIG. 3 is a front, cross-sectional, elevation view of an example respirator assembly and an example facepiece in accordance with various embodiments of the present disclosure;

FIG. 4 is a cross-sectional view of an example respirator assembly and an example facepiece in accordance with various embodiments of the present disclosure;

FIG. 5 is an angled view of an example respirator connected to an example facepiece in accordance with various embodiments of the present disclosure;

FIG. 6 is a top angle view of an example threaded adaptor in accordance with various embodiments of the present disclosure;

FIG. 7 is a front elevation view of an example threaded connector in accordance with various embodiments of the present disclosure;

FIG. 8 is a detail view of an example facepiece in accordance with various embodiments of the present disclosure;

FIG. 9 is a detail view of an example cavity insert in accordance with various embodiments of the present disclosure; and

FIG. 10 is a flow chart illustrating an example method of use for an example respirator assembly.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

### Overview

According to various embodiments, one or more respirator assemblies may be fitted to a facepiece for use as a respirator. In some embodiments, the one or more respirator assemblies may include a connector, an adaptor, a gasket, and a respirator cartridge. In some embodiments, the connector and adaptor may be configured to fit together by means of threading on their respective surfaces. In some embodiments, the threading may be bayonet threading.

In some embodiments, the connection formed by the threaded portions may be strong and difficult to disengage such that the components of the respirator assembly as securely fitted together. In some embodiments, the threaded portions may be disengaged only by deliberately manipulating one or more of the connector or the adaptor with respect to the other, such that the two components cannot be disengaged otherwise during normal operation (i.e., excluding any sudden blunt trauma or other catastrophic failure of the respirator assembly).

In some embodiments, the connector may include one or more mechanical stops that may be insertable into one or more cavities on the facepiece. In some embodiments, the mechanical stops may interface with the cavities such that the connector cannot rotate or otherwise move freely relative to the facepiece, even when the adaptor is removed from the connector, or vice-versa. In some embodiments, the threaded connection between the connector and the adaptor may connect with the facepiece in the middle of the mechanical stoppers to further prevent free spinning/movement of the connector relative to the facepiece.

### Example Facepieces

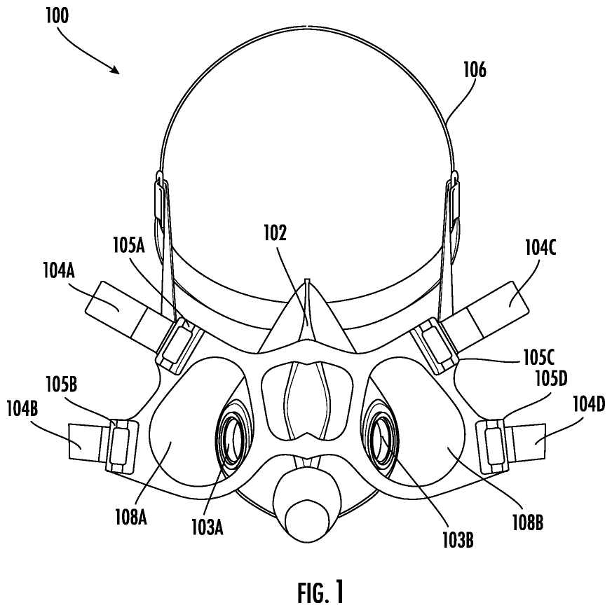

FIG. 1 shows a front elevation view of an example facepiece 100, according to various embodiments. In some embodiments, the facepiece 100 may be a facepiece for a respirator. In some embodiments, the facepiece 100 may include a shell 102. In some embodiments, the shell 102 may include one or more attachment slots 103A and 103B. In some embodiments, the attachment slots 103A-B may be disposed in parallel positions on the shell 102. In some embodiments, the shell 102 may be placed over a user's face and, in particular, a user's nose and mouth such that the user's respiration is regulated through the shell 102. In some embodiments, the shell 102 may be made of plastic and may be deformable or semi-deformable to fit various face types for various users. In some embodiments, the attachment slots 103A-B may be configured to receive one or more components of a respirator assembly 200, as will be described in greater detail later in this disclosure.

In some embodiments, the facepiece 100 may include a plurality of straps 104A-D that may be adjusted to secure the facepiece 100 to various head shapes of various individuals. In some embodiments, the straps 104A-D may be secured through one or more respective loops 105A-D.

In some embodiments, the facepiece 100 may include a band 106. In some embodiments, the band 106 may be connected to the shell 102 by means of the plurality of straps 104A-D. In some embodiments, the band 106 may be configured to further secure the facepiece 100 to a user's head by wrapping the band 106 around the back of the user's head once the shell 102 is secured to the user's face. In some embodiments, the straps 104A-D may be configured to adjust the position of the band 106 with respect to the shell 102 (and, by extension, with respect to a user's head). For example, a user may pull on the straps 104A-D to tighten the facepiece 100 and vice-versa.

In some embodiments, the facepiece 100 may include one or more voids 108A and 108B. In some embodiments, the one or more voids 108A-B may be positioned adjacent to the attachment slots 103A-B. In some embodiments, the one or more voids 108A-B may be configured to receive one or more parts of a user's face. For example, users may put one or more of their ears through the one or more voids 108A-B when they are wearing the facepiece 100.

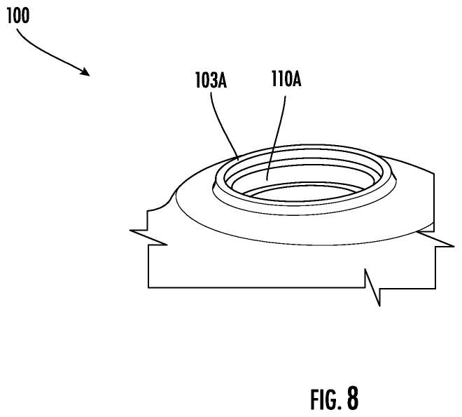

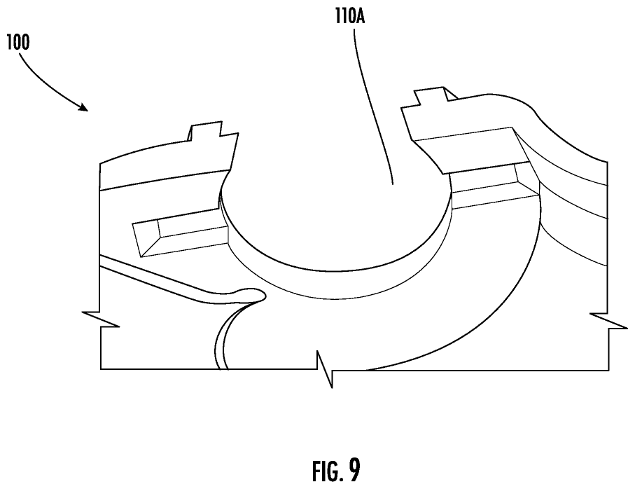

In some embodiments, and as shown in detail in FIGS. 8 and 9, the attachment slots 103A-B of the facepiece 100 may include one or more cavities 110 disposed within. In some embodiments, the one or more cavities 110 may be keyways or shafts. In some embodiments, the one or more cavities 110 may be configured to receive or otherwise interface with one or more components of the respirator assembly 200, as will be describe in greater detail later in this disclosure.

### Example Respirators and Respirator Assemblies

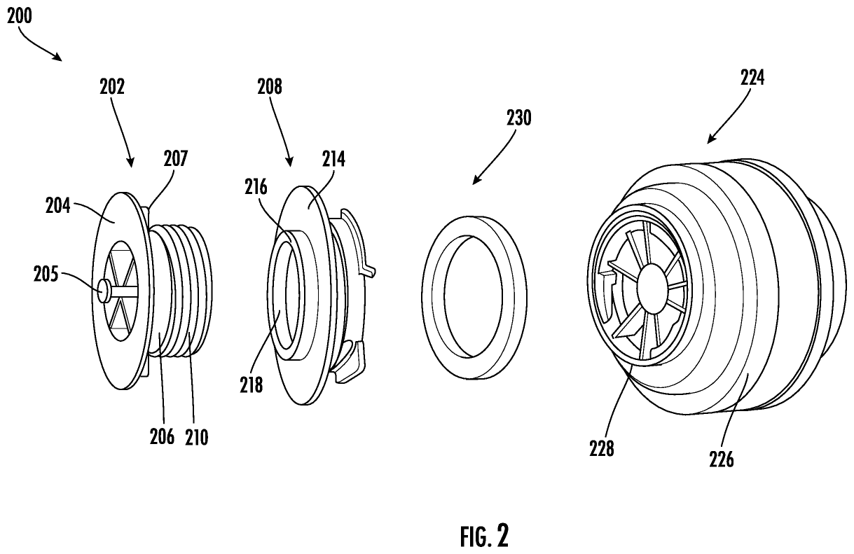

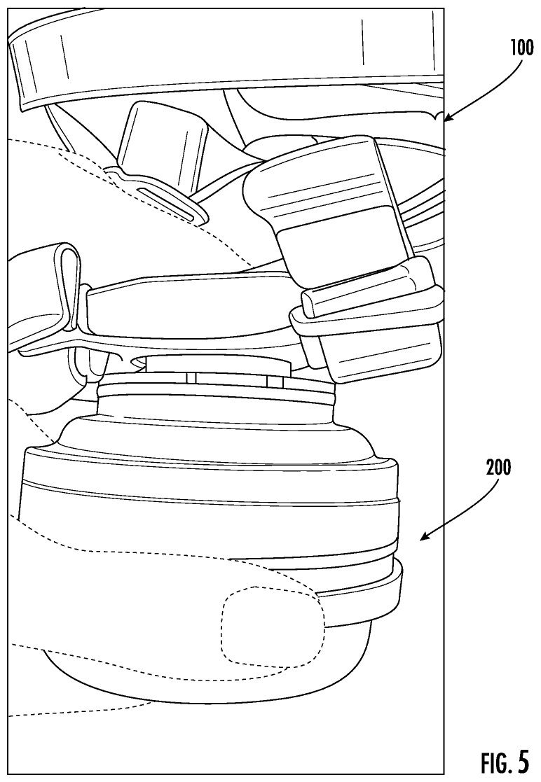

FIG. 2 shows an exploded view of an example respirator assembly 200, according to various embodiments, and as alluded to previously in this disclosure. In some embodiments, the respirator assembly 200 may include a connector 202. In some embodiments, the connector 202 may be a threaded connector. In some embodiments, the connector 202 may be configured to operably engage and/or fixedly attach the respirator assembly 200 to the facepiece 100, as shown in at least FIG. 5. In some embodiments, the connector 202 may include a connector base 204 that may be substantially circular shaped and configured to be inserted into one or more of the attachment slots 103A-B of the facepiece 100. In some embodiments, the connector base 204 may include one or more fasteners 205 (e.g., one or more screws), which may be configured to further secure the connector base 204 to the attachment slots 103A-B. In some embodiments, there may be one or more corresponding fastener holes on the facepiece 100 (e.g., screw holes) configured to receive the one or more fasteners 205.

In some embodiments, the connector 202 may include a connector column 206 that may be hollow, substantially cylindrical shaped, and configured to slot into one or more other components of the respirator assembly 200. In some embodiments, the connector column 206 may include one or more connector threading 210 on its outer surface that may aid in forming this connection between the one or more other components of the respirator assembly 200.

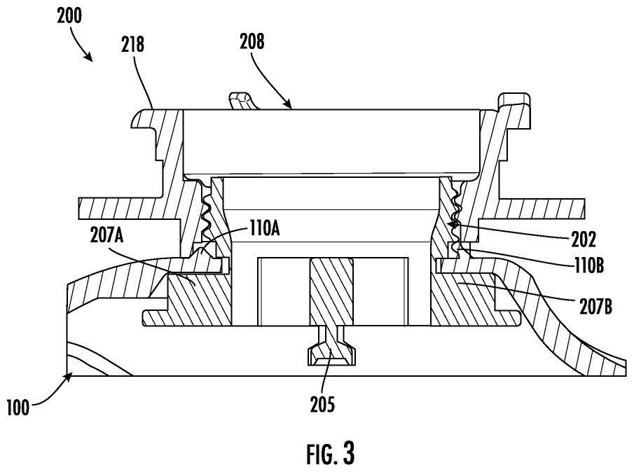

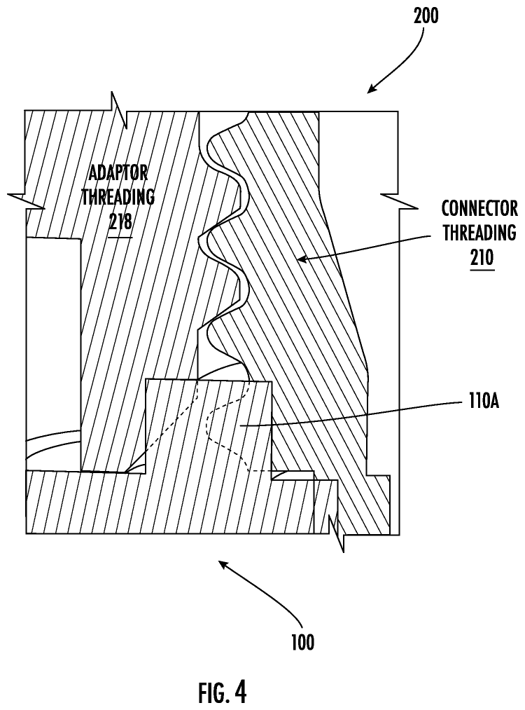

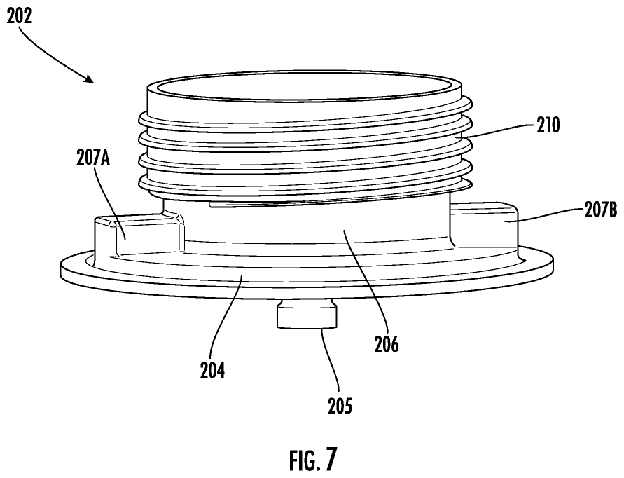

In some embodiments, and as shown in greater detail in FIG. 7, the connector 202 may include one or more mechanical stops 207A-B that may be configured to further secure the connector 202 to the one or more other components of the respirator assembly 200. In some embodiments, the one or more mechanical stops 207A-B may be positioned on one or more sides of the connector base 204. In some embodiments, the mechanical stops 207A-B may be inserted into or otherwise interface with the cavities 110. This connection can be seen in at least FIGS. 3 and 4. In some embodiments, the mechanical stops 207A-B may be configured to prevent the connector 202 from spinning or freely moving when the connector 202 is secured within the facepiece 100.

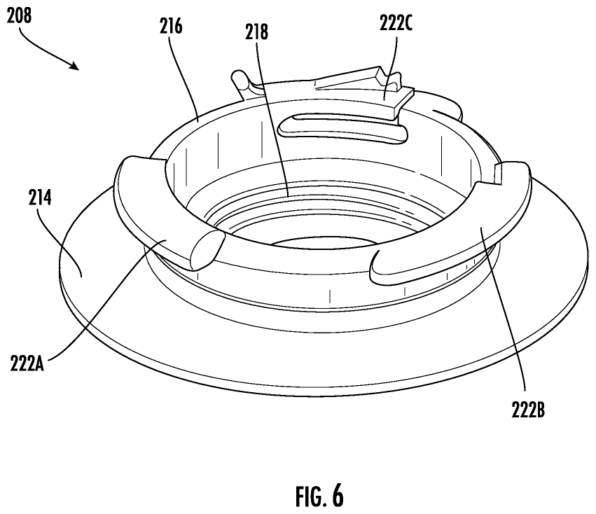

In some embodiments, and as shown in at least FIGS. 2 and 6, the respirator assembly may include an adaptor 208. In some embodiments, the adaptor 208 may be a threaded adaptor. In some embodiments, the adaptor 208 may be configured to operably engage and/or fixedly attach various components of the respirator assembly 200. In some embodiments, the adaptor 208 may be configured to operably engage and/or fixedly attach the connector 202 to a respirator cartridge 224. In some embodiments, the adaptor 208 may be substantially plastic.

In some embodiments, the connector 202 an/or the adaptor 208 may be composed of polypropylene and glass fiber material. In some embodiments, the connector 202 and/or the adaptor 208 may be composed of 70% polypropylene and 30% glass fiber material.

In some embodiments, the adaptor 208 may include an adaptor base 214. In some embodiments, the adaptor base 214 may be substantially circular. In some embodiments, the adaptor 208 may include an adaptor column 216. In some embodiments, the adaptor column 216 may be disposed through the adaptor base 214. In some embodiments, the adaptor column 216 may have an inner surface and an outer surface. In some embodiments, the adaptor column may include adaptor threading 218 defined on its inner surface. In some embodiments, the adaptor threading 218 may be configured to interface with the connector threading 210 and thereby form a threaded connection. In some embodiments, the adaptor column 216 may include a lip 220. In some embodiments, the adaptor column 216 may include one or more adaptor protrusions 222A-C. In some embodiments, the lip 220 and the one or more adaptor protrusions 222A-C may be disposed on the outer surface of the adaptor column 216.

In some embodiments, and as shown in at least FIGS. 2 and 5, the respirator assembly 200 may include a respirator cartridge 224. In some embodiments, the respirator cartridge 224 may provide an assigned protection factor of 10 when the respirator cartridge 224 is fitted with a filter. In some embodiments, the respirator cartridge 224 may be configured to filter air for various particulates and hazards. In some embodiments, the respirator cartridge 224 may include a housing 226. In some embodiments, the housing 226 may be substantially cylindrical or spherical shaped. In some embodiments, the housing 226 may include a fitment portion 228 that may be configured to be fitted to the adaptor 208. In some embodiments, the one or more adaptor protrusions 222A-C may be configured to fit into the fitment portion 228 to further secure the adaptor 208 to the respirator cartridge 224. In some embodiments, the respirator cartridge 224 may include a filter configured to remove toxins and other environmental hazards as they pass through the respirator assembly 200. In some embodiments, the filter may be disposed within the housing 226. In some embodiments, the housing 226 may be configured to be opened such that the filter may be replaced as needed.

In some embodiments, the respirator assembly 200 may include a gasket 230. In some embodiments, the gasket 230 may be positioned between the respirator cartridge 230 and the adaptor 208. In some embodiments, the gasket 230 may be configured to fit around the adaptor column 216. In some embodiments, the gasket 230 may be secured in place by the lip 220 of the adaptor column 216.

### Example Methods of Use

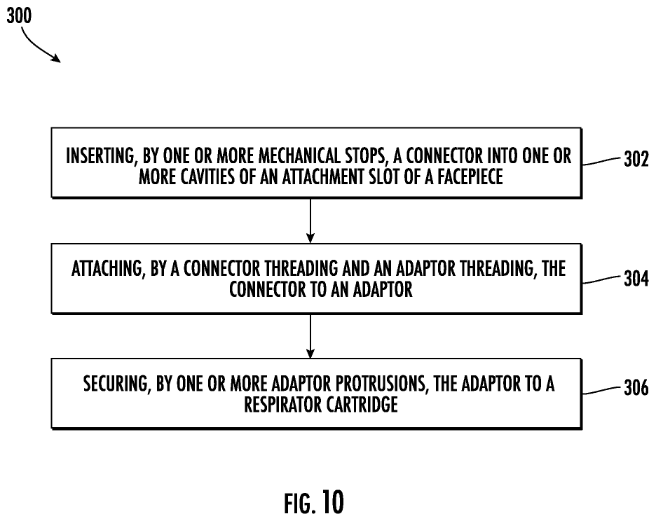

FIG. 10 shows a flow chart illustrating an example method 300 for using a respirator assembly. In some embodiments, the method 300 may be used with respect to the facepiece 100 and respirator assembly 200 and their various components, as previously described, but in some embodiments the method 300 may be used with other suitable systems, assemblies, and components, as desired. In some embodiments, one or more of the steps of the method 300 may be performed sequentially, and in some embodiments one or more of the steps of the method 300 may be performed simultaneously.

In some embodiments, the method 300 may include a first step 302 of inserting, by one or more mechanical stops, a connector into one or more cavities of an attachment slot of a facepiece. In some embodiments, the method 300 may include a second step 304 of attaching, by a connector threading and an adaptor threading, the connector to an adaptor. In some embodiments, the method 300 may include a step 306 of securing, by one or more adaptor protrusions, the adaptor to a respirator cartridge.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A respirator comprising:
a connector comprising a connector base and a connector column,
wherein the connector base defines one or more mechanical stops,
wherein the connector column defines connector threading;
an adaptor comprising an adaptor base and an adaptor column,
wherein the adaptor column defines adaptor threading configured to operably engage with the connector threading of the connector such that the adaptor and the connector are operably engaged;
a respirator cartridge comprising a housing; and
a facepiece comprising one or more attachment slots defining one or more cavities,
wherein the one or more cavities are configured to receive the one or more mechanical stops such that the connector refrains from moving relative to a facepiece.

2. The respirator of claim 1, wherein one or more of the connector threading and the adaptor threading comprise bayonet threads.

3. The respirator of claim 1, further comprising
a gasket disposed between the adaptor and the respirator cartridge,
wherein the adaptor column further defines a lip on its outer surface, and
wherein the gasket is configured to be operably engaged with the lip of the adaptor.

4. The respirator of claim 1, wherein the respirator cartridge is configured to receive one or more filters within the housing.

5. The respirator of claim 1, wherein the respirator assembly is configured to be operably engaged with a facepiece.

6. A method for using a respirator assembly, the method comprising:
inserting, by one or more mechanical stops, a connector into one or more cavities of an attachment slot of a facepiece;
attaching, by a connector threading and an adaptor threading, the connector to an adaptor; and
securing, by one or more adaptor protrusions, the adaptor to a respirator cartridge.
